(19) United States
(12) Patent Application Publication
(10) Pub. No.: US 2003/0024730 A1
(43) Pub. Date: Feb. 6, 2003

(54) Filaments for composite oxide superconductors

(76) Inventors: Alexander Otto, Chelmsford, MA (US); Jeffrey D. Schreiber, Middleton, MA (US)

Correspondence Address: HALE AND DORR, LLP, 60 STATE STREET, BOSTON, MA, 02109

(21) Appl. No.: 09/954,123

(22) Filed: Sep. 17, 2001

Related U.S. Application Data
(60) Provisional application No. 60/232,732, filed on Sep. 15, 2000.

(51) Int. Cl. H01B 12/00

(52) U.S. Cl. 174/125.1

(57) ABSTRACT

A multifilamentary superconducting composite article produces from a multifilament assembly which includes a plurality of oxide superconducting filaments in a ductile metal matrix arranged about a central core, the filaments generally having a trapezoidal cross-section. Methods of manufacture are provided.

This application is related to a PCT International Application and an U.S. application entitled, “Superconducting Articles Having Low AC Loss,” filed on an even day herewith. This application claims the priority of U.S. Provisional Application No. 60/232,732, filed Sep. 15, 2000.

### FIELD OF THE INVENTION

This invention relates to high-performance oxide superconductor articles. The present invention further relates to superconducting composite articles with reduced defect levels and improved Jc performance. The present invention also relates to multifilament composite oxide superconductors and methods for preventing microcracking and other structural defects typically formed during processing.

### BACKGROUND OF THE INVENTION

Since the discovery of the first high transition temperature oxide superconductors 15 years ago, there has been great interest in developing high temperature superconducting conductors for use in high current applications such as power transmission cables, motors, magnets and energy storage devices. These applications will require wires and tapes with high engineering critical current densities, robust mechanical properties, and long lengths manufacturable at reasonable cost. Superconducting oxide materials alone do not possess the necessary mechanical properties, nor can they be produced efficiently in continuous long lengths. Superconducting oxides have complex, brittle, ceramic-like structures, which cannot by themselves be drawn into wires or similar forms using conventional metal-processing methods. Moreover, they are subject to electromagnetic effects known as induction and flux flow, which lead to extensive energy dissipation, taxing the refrigeration and potentially overheating the conductor.

Consequently, the more useful forms of high temperature superconducting conductors are usually composite structures in which the superconducting oxides are supported by a matrix material, typically a noble metal such as silver, or a silver alloy, which adds mechanical robustness to the composite and provides good thermal dissipation in the event of magnetic field-induced energy dissipation. These composite structures attempt to balance the desirable mechanical properties of the supporting matrix material with the desired electrical properties of the superconducting oxides. Thus, it is an important design consideration to construct a composite that balances the desired thermomechanical properties of the supporting matrix material with the desired electrical properties of the superconducting material.

Generally, composites may be prepared in elongated forms such as wires and tapes by the well-known “powder-in-tube” or “PIT” process which includes the three stages of: forming a powder of superconductor precursor material (precursor powder formation stage); filling a noble metal billet with the precursor powder, longitudinally deforming and annealing the bundle to provide a composite of reduced cross-section including one or more filaments of superconductor precursor material in a surrounding noble metal matrix (composite precursor fabrication stage); and subjecting the composite to successive asymmetric deformation and annealing cycles and further thermally processing the composite to form and sinter a core material having the desired superconducting properties (thermomechanical processing stage).

In the composite precursor fabrication stage, longitudinal deformation operations, i.e., wire drawing and/or extrusion, which form the billet or bundle into an elongated shape such as a wire or tape are followed by low temperature anneals, typically on the order of 200° C. to 450° C. in air, or insert atmosphere, for silver or a silver alloy to relieve strain energy introduced by deformation, without causing substantial reaction of the precursor powder or melting or grain growth in the silver or silver alloy.

The deformation portions of the deformation and annealing cycles in the thermomechanical processing stage are asymmetric deformations which create alignment of precursor grains in the core (“textured” grains) which facilitate the growth of well-aligned and sintered grains of the desired superconducting material during later thermal processing stages. Examples are rolling and isostatic pressing cycles described in U.S. Pat. No. 6,069,116, and U.S. patent application Serial No. 07/906,843, filed Jun. 30, 1992 entitled “High Tc Superconductor and Method for Making It,” which are herein incorporated by reference in their entirety.

Many composites in the prior art are multifilamentary structures. In preparation of these multifilamentary articles, individual filaments of superconducting material are covered with a matrix material, and the filaments are bundled together and encased within a cylindrical metallic tube to form a billet that is processed to the desired dimensions and shape. Typically, as shown in FIG. 1, the individual filaments 200 possess a hexagonal or “honeycomb” cross-section, and are bundled to form a filamentary unit 210 having a saw-tooth perimeter 220. Because of the inherent angularity of the hexagonal filaments, appreciable gaps 230 occur between the perimeter of the filamentary unit 210 and the inner surface of the cylindrical metallic tube 250. The gaps 230 are most prominent where the intersection of two adjacent hexagonal filaments at the perimeter of the filamental unit produce 120 degree “valleys” 260. In order to lessen the size of these gaps 230, cylindrical metallic rods 270, otherwise known as “metallic shims” having a diameter relatively smaller than the diameter of the filaments, are usually inserted in these valleys 260. As shown in FIG. 1, these gaps 230 are only partially filled by the metallic shims 270. The prohibitive cost and complexity of manufacturing these metallic shims and the necessity of having to individually insert them into gaps 230 has created a need for an alternative composite architecture. Furthermore, the shims themselves are typically silver or silver-based rods, and therefore, take up valuable fill space that would preferably be taken up by superconducting-filled filaments.

After the gaps 230 are partially filled, a consolidation step is normally required for a hexagonal filament composite in order to substantially completely eliminate voids. As described in U.S. Pat. No. 6,069,116, which is hereby incorporated by reference in its entirety, the bundled filaments are typically consolidated using heat and isostatic pressure, typically hot isostatic pressing (hereafter “HIPing”), under conditions sufficient to substantially eliminate voids in the article without buckling the filaments, and to promote grain growth of the constraining metal. HIPing is conducted normally in an inert gas, typically at a pressure in the range of about 3 atm to about 999 atm, and a temperature in the range of about 200° C. to about 750° C. for a time in the range of about 1 hour to about 36 hours.

The prior art hexagonal filament architecture presents problems in addition to an undesirable fill factor caused by the gaps. During thermomechanical processing, whether during the HIPing process, or during subsequent deformation steps, the inherent nature of the hexagonal filaments may cause defects in the structure of the composite superconductor article. The saw-tooth perimeter of the hexagonal filamental unit often induces the formation of cracks in the cylindrical metallic tube 250, leading to either microcracking or fractures, or even splitting of the tube itself. For instance, when isostatic pressure is applied to consolidate the various filaments to each other and to the surrounding matrix material, the sharp angles of the hexagonal filaments may drive into, crack, or puncture the surface of the cylindrical metallic tube 250 and any other matrix material surrounding the filament, impairing the integrity of the tube.

Likewise, during subsequent deformation steps to elongate and to induce texturing of the superconducting material, such as rolling, pressing, extruding, drawing or twisting, the angularity inherent in filaments having a polyhedral cross-section such as hexagonal filaments causes fractures and surface defects in the billet and subsequently, in the rolled tape. For instance, when the bundle of filaments is processed lengthwise during thermomechanical processing such as rolling, the persistence of a rough-textured perimeter results in pressure points that cause perforation of the metallic sheath. These defects decrease the electrical performance of the superconducting article and lead to loss in Je and Ic levels. In order to prevent such defects, several step-up deformation steps are normally required using non-uniform deformation that avoids adding pressure to sensitive stress points near the saw-tooth perimeter of the hexagonal filamental bundle. Also, it is often required that the thickness of the cylindrical tube is increased beyond an optimum thickness in order to prevent perforation of the tube walls.

Thus, it is desirable to provide architectures for multifilament bundles that produce superconducting articles with reduced defect levels and improved electrical performance. It is also desirable to provide monofilament and multifilament assemblies and processing methods that avoid cracks or stress fractures while imparting the desired degree of texturing, core density and hardness to the finished superconducting oxide article.

### SUMMARY OF THE INVENTION

The present invention provides an oxide superconducting composite which overcomes the limitations of the prior art to provide a composite superconducting oxide material with improved electrical properties.

The present invention also provides a superconducting article having the mechanical robustness necessary to survive processing into the final oxide superconductor.

In one aspect, this invention provides a monofilament rod for use in preparing a multifilament oxide superconducting strand, comprising an oxide filament in a ductile metal matrix, said oxide comprising an oxide superconductor or precursor thereto wherein the rod has a cross-sectional geometry of a quadrilateral having two opposing sides of same or unequal length connected by two linear sides of the same or unequal length. In some embodiments, the two opposing sides comprise two concentric arcs of unequal length comprising a larger outer arc and a smaller inner arc. In other embodiments, the quadrilateral is selected from the group consisting of a trapezoid and a trapezium. In other embodiments, the length of the outer arc is greater than the length of the inner arc such that an angle between the two linear sides of the quadrilateral is from about 10 to about 180 degrees, in other embodiments, the angle is from about 20 to about 60 degrees, and in still other embodiments, the angle is about 20 to about 45 degrees.

In still other embodiments, the cross-sectional geometry of the rod comprises a trapezoid.

In terms of materials, the ductile metal matrix comprises silver or a silver alloy. In some embodiments, the oxide superconductor comprises a bismuth-strontium-calcium-copper oxide (BSCCO) superconductor, such as for example a lead bismuth-strontium-calcium-copper oxide (BSCCO) superconductor. However, all high temperature superconducting materials with transition temperature exceeding about 50 K, as well as some low temperature superconducting materials like Nb—Ti, Nb₃Sn, and MgB₂ are within the scope of the invention.

In another aspect, the present invention provides a monofilament rod for use in preparing a multifilament oxide superconducting strand comprising an oxide filament in a ductile metal matrix, said oxide comprising an oxide superconductor or precursor thereto wherein the rod possesses a space-filling geometry such that, when multiple monofilament rods are assembled into a billet, such assembly is characterized by the absence of sharp angles. In some embodiments, the billet is a cylindrical tube containing an array of monofilaments having a cross-section geometry of a quadrilateral and said monofilaments are arranged about a central core. The quadrilateral may comprise a trapezoid.

In another aspect, the present invention provides a multifilamentary assembly for forming a superconducting composite article comprising a plurality of oxide superconducting filaments in a conductive, ductile metal matrix arranged about a central core to form a filament bundle. Each filament has a cross-sectional geometry of a quadrilateral having two opposing sides of same or unequal length connected by two linear sides of the same or unequal length. In addition, in some embodiments, a metallic sheath having an outer diameter and an inner diameter substantially surrounds the outermost surface of the filament bundle.

In some embodiments, the two opposing sides comprise two concentric arcs of unequal length comprising a larger outer arc and a smaller inner arc. In other embodiments, the quadrilateral is selected from the group consisting of a trapezoid and a trapezium. In at least some embodiments, the length of the outer arc is greater than the length of the inner arc such that an angle between the two linear sides of the quadrilateral is from about 10 to about 180 degrees, or from about 20 to about 60 degrees, or alternatively, from about 20 to about 45 degrees. As used herein, the angle between two linear sides can be readily determined by extending the linear sides to intersect at a vertex, and measuring the angle between the two linear sides using the vertex as the reference point.

In one embodiment, each filament possesses a space-filling geometry such that, when multiple monofilament rods are assembled into a billet, such assembly is characterized by the absence of sharp angles. In another embodiment, the central core of the multifilament assembly comprises an array of filaments having a cross-section geometry of a quadrilateral and the filaments are arranged about a second central core.

In yet another embodiment, the assembly has a superconducting fill factor of greater than about 35%. In other embodiments, the assembly has a superconducting fill factor of greater than about 40%.

In yet another embodiment, the filaments of the assembly are arranged about a central core selected from the group consisting of an electrically resistive core, a conductive core, and an oxide superconductor core. The filaments may also be arranged in a single concentric layer about the central core, or in multiple concentric layers about the central core.

In some embodiments, the assembly comprises two layers of filaments: a first concentric layer is comprised of filaments having arcs of uniform length, and a second concentric layer is comprised of filaments having arcs of uniform length different from that of the first concentric layer. Alternatively, the first concentric layer is comprised of filaments having arcs of unequal length and linear sides of uniform length arranged about the central core, and a second concentric layer arranged about the first concentric layer, the second concentric layer comprised of filaments having arcs of unequal length and linear sides of uniform length.

In some embodiments, the multifilamentary assembly is comprised of from about 3 to about 1000 oxide superconducting filaments, in other embodiments about 6-50 oxide superconducting filaments, and yet in other embodiments, about 6-18 oxide superconducting filaments.

In yet another embodiment, the filaments are arranged around a core to form a filament bundle and the diameter of the filament bundle is less than the inner diameter of the metallic sheath by less than about 10%. In some embodiments, the diameter of the filament bundle is about 2% less than the inner diameter of the metallic sheath.

In another aspect, the present invention provides a method of making a multifilamentary superconducting composite article, comprising the following steps. In a first step, an elongated multifilamentary assembly is formed comprising a plurality of oxide filaments in a ductile metal matrix assembled about a central core to form a filament bundle, wherein each filament has a cross-sectional geometry of a quadrilateral having two opposing sides of same or unequal length connected by two linear sides of the same or unequal length, and said oxide comprises an oxide superconductor or precursor thereto. In a second step, the assembly is processed to reduce its cross-sectional area, to adhere the various elements of the assembly to one another, and to induce texture in the precursor oxide filaments under conditions. In a third step, the precursor oxide is converted into an oxide superconductor, whereby a multifilamentary superconducting composite is obtained. In certain embodiments, the step of forming an elongated multifilamentary composite comprises introducing a metallic sheath around the filament bundle to produce a filament bundle/sheath composite and deforming the composite to reduce the diameter of a cross-section of the composite.

In some embodiments, the composite is textured by a large reduction rolling on the order of 40-85% reduction in thickness. In other embodiments, the composite is textured in a constrained rolling operation.

In another aspect, the present invention provides a superconducting composite article comprising a plurality of oxide superconducting filaments in a conductive ductile metal matrix, produced according to the method described above, wherein the article has a cross-sectional width in the range of about 100-8000 μm and a cross-sectional thickness in the range of about 25-500 μm. Alternatively, the article has a cross-sectional width less than about 300 μm and a cross-sectional thickness less than 100 μm.

In terms of materials, in some embodiments of the above discussed monofilament rod, multifilament assembly, multifilament composite strand or tape, and methods of making these articles, the conductive matrix metal is made of silver or silver-based compounds. In some embodiments, the oxide superconductor comprises a bismuth-strontium-calcium-copper oxide (BSCCO) superconductor, particularly a lead-bismuth-strontium-calcium-copper oxide (BSCCO) superconductor. In addition, any high temperature superconducting material that has a transition temperature exceeding about 50K, as well as some low temperature superconducting materials like Nb—Ti, Nb₃Sn, and MgB₂ are within the scope of the invention.

By “adherent,” as that term is used herein, is meant a metallurgical bond between the components of the article. A metallurgical bond is one in which the bond between two materials forms an interface that is free of voids, contaminating films, or discontinuities. Contact and bonding between the two materials is on an atomic level.

By “matrix,” as that term is used herein, is meant a material or homogeneous mixture of materials which supports or binds a substance, specifically including the filaments, disposed within the matrix. By “noble metal,” as that term is used herein, is meant a metal which is substantially non-reactive with respect to oxide superconductor and precursors and to oxygen under the expected conditions (temperature, pressure, atmosphere) of manufacture and use. Silver, gold, platinum and palladium are typical noble metals. “Alloy” is used herein to mean an intimate mixture of substantially metallic phases or solid solution of two or more elements. Silver and other noble metals, and the alloys of these metals are the matrix materials in some embodiments.

By “desired oxide superconductor” or “final oxide superconductor,” as those terms are used herein, is meant the oxide superconductor intended for eventual use in the finished article. Typically, the desired oxide superconductor is selected for its superior electrical properties, such as high critical current temperature or critical current density. Members of the bismuth and rare earth families of oxide superconductors are used in at least some embodiments. By “precursor” as that term is used herein, is meant any material that can be converted into a desired oxide superconductor under suitable heat treatment.

As used herein, “quadrilateral” means any four-sided geometric shape, where any of the sides may be linear, substantially linear, or a curved line such as an arc of a circle.

As used herein, “trapezoid” or “quasi-trapezoid” means a quadrilateral having one pair of parallel sides, or one pair of concentric arcs connected to substantially linear sides of the same or unequal lengths. Some or all sides may be completely linear and also may be partially linear. For instance, the sides may contain curves at each end, where they are connected to adjacent sides such that the trapezoid may contain rounded corners to form for example, a “truncated pie-shape.”

As used herein, “trapezium” means a quadrilateral having no parallel sides. Some or all sides may be completely linear and also may be partially linear. For example, the sides may contain curves at each end, where they are connected to adjacent sides such that the trapezoid may contain rounded corners.

### BRIEF DESCRIPTION OF THE DRAWING

The invention is described with reference to the following figures, which are presented for the purpose of illustration only and which are not intended to be limiting of the invention, and in which:

FIG. 1 is a schematic cross-section illustration of a prior art multifilamentary composite comprised of a bundle of 19 hexagonally-shaped or “honeycomb” filaments.

FIG. 2 is a schematic cross-section illustration of a precursor monofilament having a generally trapezoidal cross-section geometry prior to bundling. The trapezoidal rod includes a precursor powder core surrounded by an outer silver or silver alloy matrix.

FIG. 3 is a schematic cross-section illustration of a multifilament composite comprised of an array of filaments having a trapezoidal cross-section surrounding a central cylindrical monofilament rod.

FIG. 4 is a schematic cross-section illustration of two arrays of multifilament strands formed of trapezoidal filaments surrounding a central cylindrical monofilament rod.

FIG. 5 is a photomicrograph of a multifilament strand after consolidation.

FIG. 6 is a photomicrograph of a multifilament strand after final processing into a textured oxide superconductor.

FIG. 7A is a schematic illustration of the die sequence employed to shape a standard cylindrical monofilament rod of circular cross-section into the filament having a trapezoidal cross-section of the present invention.

FIG. 7B is a schematic illustration of the final die shape used to create the trapezoidal cross-section monofilament rod of the present invention. This configuration provides for a bundle of 12 filaments, with a central core comprising an additional filament that is round in cross section and about 0.6 inches in diameter.

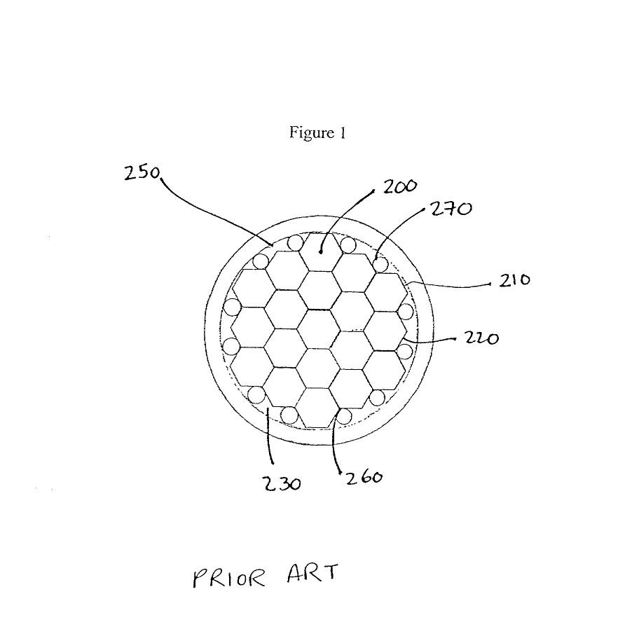

### DESCRIPTION OF THE PREFERRED EMBODIMENTS

The present invention provides an oxide superconductor multifilamentary composite article including a plurality of oxide superconducting filaments in a ductile metal matrix.

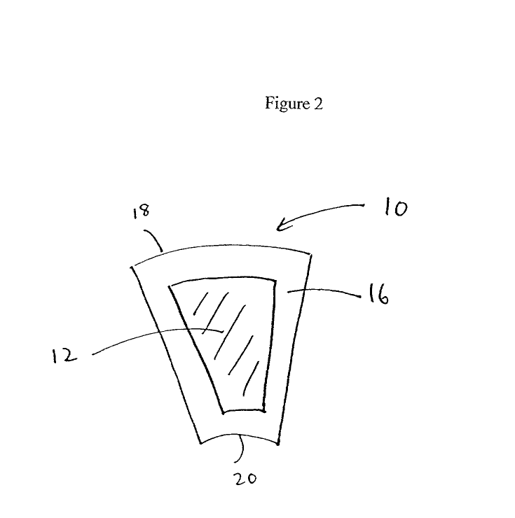

Referring to FIG. 2, a monofilament is formed having a generally trapezoidal, “truncated pie-shaped” cross-section. The monofilament 10 includes an inner oxide superconductor core 12 (or precursor thereto) in a conductive metal matrix 16. The superconducting filament may be a relatively phase pure oxide superconductor, or it may contain elongated bands of materials such as silver, silver alloys, or other metals that can enhance texture and current density in the superconducting oxide. The core 12 may also include a cross-section of multiple distinct regions of superconducting material surrounded by a metal matrix. It has been demonstrated that oxide superconductor grains will align along a silver interface. By providing multiple conductive pathways within the oxide superconductor matrix for alignment, texture can be enhanced.

In some embodiments, the monofilament comprises an oxide filament in a ductile metal matrix, said oxide comprising an oxide superconductor or precursor thereto wherein the rod has a cross-sectional geometry of a quadrilateral having two opposing sides of same or unequal length connected by two linear sides of the same or unequal length. In some embodiments, the two opposing sides comprise two concentric arcs of unequal length comprising a larger outer arc and a smaller inner arc. In other embodiments, the quadrilateral is selected from the group consisting of a trapezoid and a trapezium. In other embodiments, the length of the outer arc is greater than the length of the inner arc such that an angle between the two linear sides of the quadrilateral is from about 10 to about 180 degrees, in other embodiments, the angle is from about 20 to about 60 degrees, and in still other embodiments, the angle is about 20 to about 45 degrees.

The monofilament rod for use in preparing a multifilament oxide superconducting strand may alternative comprise an oxide filament in a ductile metal matrix, the oxide comprising an oxide superconductor or precursor thereto wherein the rod possesses a space-filling geometry such that, when multiple monofilament rods are assembled into a billet, such assembly is characterized by the absence of sharp angles. In some embodiments, the billet is a cylindrical tube containing an array of monofilaments having a cross-section geometry of a quadrilateral and said monofilaments are arranged about a central core. The quadrilateral may comprise a trapezoid.

In at least some embodiments, the matrix metal is silver-based. In some other embodiments, the metal matrix 16 is pure silver, or a silver alloy. In some embodiments, the matrix is composed of ODS silver. The dispersed oxide content of the ODS silver alloy may be adjusted downward to provide a ductile composite, which helps to maintain composite flexibility while imparting other desirable properties to the article. A pure silver metal matrix generally promotes higher conductivity adjacent to the superconducting filament core, which may serve as an electrical shunt in the event of filament breakage.

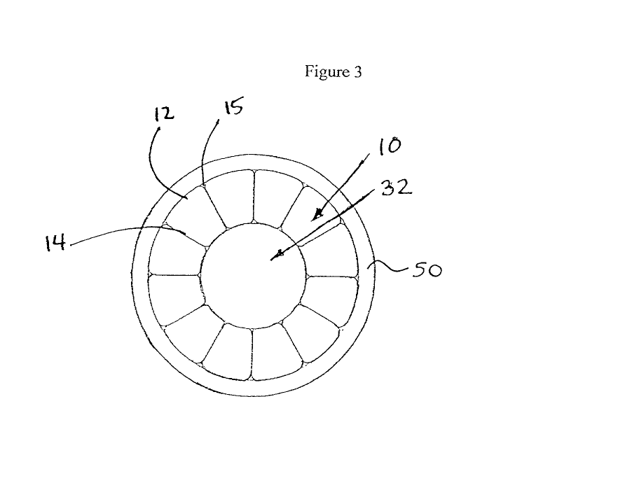

In another aspect of the invention, a plurality of the monofilaments described above are arranged within a cylindrical metal sheath to form a multifilamentary assembly 30 having a fill factor that is significantly higher than those shown in prior art composites. This multifilamentary assembly, once processed into a finished composite, may alternately be referred to as a strand or tape. With reference to FIG. 3, a plurality of monofilaments 10 are arranged about an optional central core 32. The filaments 10 are consolidated to provide a perimeter ring of oxide superconducting filaments 12 in a metal matrix 15, and each filament is separated from its neighbors by a metallic matrix layer, which in at least some embodiments is a noble metal such as silver, or a noble metal alloy such as a silver alloy 14. The multifilamentary assembly typically includes between 3 and 1000 filaments. In some embodiments, there are between 6 and 50, in other embodiments between 6 and 18, and in yet other embodiments between 6 and 13 filaments per multifilamentary assembly. The components of the assembly are processed to form a fully-bonded, adherent, and integrated strand.

In some embodiments, the multifilamentary assembly is comprised of from about 3 to about 1000 oxide superconducting filaments, in other embodiments 6-50 oxide superconducting filaments, and yet in other embodiments, 6-18 oxide superconducting filaments. In yet another embodiment, the filaments are arranged around a core to form a filament bundle and the diameter of the filament bundle is less than the inner diameter of the metallic sheath by less than about 10%. In some embodiments, the diameter of the filament bundle is about 2% less than the inner diameter of the metallic sheath.

In yet another embodiment, the assembly has a superconducting fill factor of greater than about 35%. In other embodiments, the assembly has a superconducting fill factor of greater than about 40%. As used herein, fill factor of superconducting material is measured by dividing the total cross-sectional area of the superconducting filament by the total cross-sectional area of the superconducting filament plus non-superconducting material, e.g. silver (matrix silver and silver tubing).

In at least some embodiments, the center core 32 of each multifilament assembly is a monofilament having a cylindrical cross-section 10. An oxide superconductor monofilament core increases the fill factor of the strand, i.e., the volume of the strand occupied by oxide superconductor material. This results in improvements to both the critical current, I_{c}, and the engineering critical current density, Jₑ, of the strand.

In some embodiments, a bundle of filaments each having an outer radius matching the inner radius of a cylindrical metallic tube, minus a small amount to leave a gap that allows packing of the monofilaments inside the tube without abrasion, are assembled inside the tube 50 to form a multifilament assembly. In some embodiments, each of the monofilament rods that line the inside perimeter of the tube 50 is a standard and readily available cylindrical rod that has been shaped such that it has a generally trapezoidal cross-section, but with concentrically curved inner and outer surfaces to allow better mating with the inner perimeter of the tube 50 and also to form a cylindrical central hole in the core of the tube. In one embodiment, a single standard cylindrical filament having a diameter only slightly less than the central hole is inserted to form the central core 32 of the assembly.

In another embodiment, another bundle of multifilaments having a trapezoidal cross-section is placed within the central hole. Since no shims are required to fill gaps between the filaments and the inner wall of the cylindrical metallic tube, a significant fraction of the cavity of the tube is occupied by filaments containing superconducting material.

In addition to the trapezoidal, quasi-trapezoidal or truncated pie-shape cross-sections, one of skill in the art would appreciate that this invention encompasses other non-hexagonal space-filling monofilament shapes that may be used. For instance, using available information about mathematical tiling principles, one of skill in the art could readily use additional space filling shapes for the monofilaments having non-trapezoidal cross-sections. In addition, in some embodiments, the cylindrical metallic tube may be replaced with a metallic sheath having other cross-sectional geometric configurations such as oval, triangular, rectangular, hexagonal, and octagonal. One embodiment utilizes a cylindrical metallic tube having a circular cross-section which tends to maximize the distance between a filament and the outermost surface of the tube, which reduces stress points between the filament and the tube, lessening the risk of perforation defects.

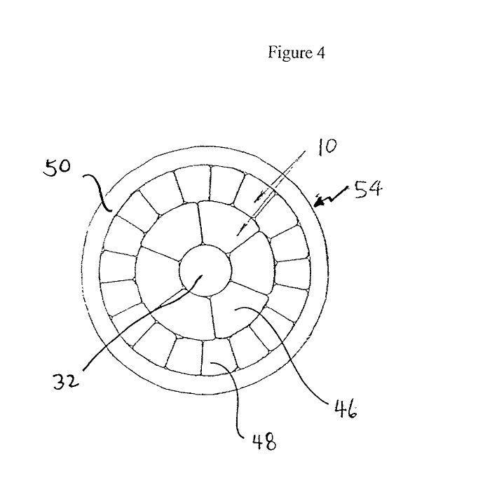

In alternative embodiments, multiple concentric filament rings and/or a resistive central core are possible. For example, the composite may include an outer perimeter filament ring 46 surrounding an inner perimeter filament ring 48 to create a multifilamentary composite 54 as is shown in FIG. 4.

Use of a resistive core, in lieu of an electrically conducting core including a superconducting core, may be desired under conditions for which decoupling is inadequate with the superconductive core, and is an alternative embodiment of the invention. In another embodiment, the filament core 32 may consist of a relatively insulating material, which assists in reducing filament coupling losses.

In some embodiments, a multifilamentary assembly is processed into a strand which is aspected and has an aspect ratio of about 2:1 to about 20:1. The strands may be prepared over a wide range of sizes and formed into a cable. In some embodiments, the strands may be relatively large, e.g., with dimensions up to 1 cm by 0.2 cm (cross-sectional area of the strand). In other embodiments, the strand may have a cross-sectional width of less than 300 μm and a cross-sectional thickness of less than 100 μm. In some embodiments, the average distance between oxide superconducting filaments in the strand is in the range of about 10 to about 100 μm. These dimensions have been identified as desirable for the current carrying capacity of the strand, while minimizing filament cross-sectional area that is associated with increased energy loss.

In other embodiments, strands have cross-sectional areas of about 0.01 to about 0.13 cm² and have a transverse aspect ratio of about 2:1 to 20:1. In some other embodiments, for some low aspect ratio strands, the transverse aspect ratio is from about 2:1 to about 4:1. Generally, low aspect strands are easier to cable. In some embodiments, about 6 to 18 perimeter oxide superconductor filaments are arranged about a core, and occupy a filament cross-sectional area of about 2.5×10⁻⁵ cm². The strand may have a twist pitch of about 0.2 to about 100 cm. The individual monofilament 10 of the composite filament as shown in cross-section in FIG. 2 are aspected to provide overall aspect ratio of the multifilament composite. Low aspect ratio filaments are desirable because the oxide superconductor fill factor is maximized.

In some embodiments, a high resistivity region is embedded within and adherent to the metal matrix, as described in co-pending U.S. application entitled “Superconductor Article Having Low AC Loss,” filed on an even day as the subject application.

In some embodiments, the oxide superconducting filaments remain physically separated from their neighboring filaments after processing into a multifilamentary composite, or strand. The multifilamentary composite may have a further outer layer, which is capable of forming an adherent bond with adjacent strands in a cable configuration and which serves to fix and stabilize the strands within a cable. The layer, in some embodiments is comprised of silver, such as pure silver or a silver alloy, or another noble metal, or a ceramic or glass that softens and permits sintering between the strands. Layer thickness is in the range of about 3 to about 30 μm.

The invention may be practiced with any desired oxide superconductor or its precursors. By “desired oxide superconductor” is meant the oxide superconductor intended for eventual use in the finished article. Typically, the desired oxide superconductor is selected for its superior electrical properties, such as high critical temperature or critical current density. By “precursor” is meant any material that can be converted to an oxide superconductor upon application of a suitable heat treatment. Precursors may include any combination of elements, metal salts, oxides, suboxides, oxide superconductors which are intermediate to the desired oxide superconductor, or other compounds which, when reacted in the presence of oxygen in the stability field of a desired oxide superconductor, produces that superconductor. For example, there may be included elements, salts, or oxides of copper, yttrium or other rare earths, and barium for the rare earth family of oxide superconductors (RBCO); elements or oxides of copper, bismuth, strontium, and calcium, and optionally lead, for the BSCCO family of oxide superconductors; elements, salts, or oxides of copper, thallium, calcium and barium or strontium, and optionally bismuth, and lead, for the thallium (TBSCCO) family of oxide superconductors; elements, salts, or oxides of copper, mercury, calcium, barium or strontium, and optionally, bismuth or lead, for the mercury (HBSCCO) family of oxide superconductors.

In some embodiments, the bismuth and rare earth families of oxide superconductors are used for operation of the invention. By “oxide superconductor intermediate to the desired oxide superconductor” is meant any oxide superconductor which is capable of being converted to the desired oxide superconductor. The intermediate oxide may alternatively be referred to as an oxide precursor to an oxide superconductor. The formation of an intermediate may be desired in order to take advantage of desirable processing properties, for example, a micaceous structure, which may not be equally possessed by the desired superconducting oxide.

Precursors are included in amounts sufficient to form an oxide superconductor. In some embodiments, the precursor powders may be provided in substantially stoichiometric proportion. In others, there may be a stoichiometric excess or deficiency of any precursor to accommodate the processing conditions used to form the desired superconducting composite. For this purpose, excess or deficiency of a particular precursor is defined by comparison to the ideal cation stoichiometry of the desired oxide superconductor. Thalliation, the addition of doping materials, including but not limited to the optional materials identified above, variations in proportions and such other variations in the precursors of the desired superconducting oxides as are well known in the art, are also within the scope and spirit of the invention.

The three-layer, high T_{c} phase of a member of the BSCCO family of superconductors, such as Bi₂Sr₂Ca₂Cu₃Oₓ (BSCCO 2223) or (Bi,Pb)₂Sr₂Ca₂Cu₃Oₓ ((Bi,Pb)SCCO 2223), is one of the desired superconducting oxides in some embodiments for the operation of the present invention. Composites including BSCCO 2223 (Bi,Pb)SCCO 2223 have demonstrated the potential for superior mechanical and electrical performance at long lengths when adequately textured. The current-carrying capacity of a superconducting oxide composite depends significantly on the degree of crystallographic alignment and intergrain bonding of the oxide grains, together known as “texturing”, induced during the composite manufacturing operation. For example, known techniques for texturing the two-layer and three-layer phases the bismuth-strontium-calcium-copper-oxide family of superconductors (BSCCO 2212 and BSCCO 2223, respectively) are described in Tenbrink, Wilhelm, Heine and Krauth, Development of Technical High-Tc Superconductivity Conference, Chicago (Aug. 23-28, 1992), and Motowidlo, Galinski, Hoehn, Jr. and Haldar, “Mechanical and Electrical Properties of BSCCO Multifilament Tape Conductors,” paper presented at Materials Research Society Meeting, Apr. 12-15, 1993.

In addition, any high temperature superconducting material that has a transition temperature exceeding about 50K, as well as some low temperature superconducting materials like Nb—Ti, Nb₃Sn, and MgB₂ are within the scope of the invention.

Any matrix material may be used which is readily formable, have high thermal conductivity, and be sufficiently non-reactive with respect to the superconducting oxides under the conditions of manufacturing and use that the properties of the latter are not degraded in its presence. Composites made by the popular powder-in-tube or PIT process, are described, for example, in U.S. Pat. Nos. 4,826,808, and 5,189,009 to Yurek et al., and Gao et al., Superconducting Science and Technology, Vol. 5, pp. 318-326, 1992; Rosner et al., “Status of HTS superconductors: Progress in improving transport critical current densities in HTS Bi-2223 tapes and coils” (presented at conference Critical Currents in High Tc Superconductor, Vienna, Austria, April, 1992); and Sandhage et al., Critical Issues in the OPIT Processing of High Jc BSCCO Superconductors, Journal of Metals, Vol. 43, 21,19, all of which are herein incorporated by reference in their entirety.

Under normal manufacturing conditions, superconducting oxides have adverse reactions with nearly all metals except the noble metals. Thus, silver and other noble metals or noble metal alloys such as a silver alloy are typically used as matrix materials, and silver is the matrix material used in many embodiments for many high performance applications . Composite metal matrices, including, for example, oxide diffusion barriers and silver or silver alloy layers between superconducting oxides and non-noble metals have also been suggested in the prior art are within the scope of this invention.

In yet another aspect, the invention provides a method of manufacturing a multifilamentary superconducting composite article having a generally trapezoidal or “truncated pie-shape” architecture that allows greater packing of filaments into a given metallic billet or sheath and provides enhanced electrical properties over standard superconductor composite tapes. The process is based upon the well-known oxide-powder-in-tube (OPIT) method.

For forming multifilamentary composite articles, the OPIT method generally includes the three stages of (a) forming a powder of superconducting precursor materials (precursor powder formation stage), (b) filling a noble metal billet with the precursor powder, longitudinally deforming and annealing it, forming a bundle of billets or of previously formed bundles, and longitudinally deforming and annealing the bundle to provide a composite of reduced cross-section including one or more filaments of superconductor precursor material surrounded by a noble metal matrix (composite forming stage); and (c) subjecting the composite to successive asymmetric deformation and annealing cycles to texture the composite, and further thermally processing the composite to form and sinter a core material having the desired superconducting properties (thermomechanical processing stage).

In some embodiments, the final oxide superconductor is BSCCO 2223 or (Bi,Pb)SCCO 2223 and the oxide precursor is BSCCO 2212 or (Bi,Pb)SCCO 2212 and additional secondary phases, e.g., BSCCO 0011, necessary to provide the proper overall stoichiometry for BSCCO 2223. In some embodiments, BSCCO 2212 plus secondary phases is the precursor oxide because the grains of BSCCO 2212 are readily densified or textured using conventional processes. For the purposes of illustration, the method is described for the BSCCO oxide superconducting system; however, it is contemplated that the method may be adapted for use in other oxide superconducting systems.

A standard cylindrical superconducting filament produced according to well-known methods is used to produce the truncated pie-shape monofilament 10 of FIG. 2. In some embodiments, the core 32 of the monofilament 10 that is to be formed is comprised of either an electrically conducting, superconducting, or resistive material. In other embodiments, the metallic matrix that surrounds the core is comprised of silver, a silver alloy, or another noble metal or noble metal alloy. The matrix/core combination is consolidated into a round rod or tube shape using standard extrusion, drawing, rolling, or isostatic pressing methods under ambient or elevated temperatures. The process is carried out under conditions of sufficiently low temperature and oxygen pressure so that no appreciable conversion of the precursor metal into its final oxide occurs.

The combination is then drilled to give a hollow bore (where necessary) into which precursor powders to the desired oxide superconductor can be introduced. The hollow bore sheaths are then filled with oxide precursor powders, sealed and drawn into monofilament rods of suitable size. In some embodiments, the cross-section of the monofilament rod is a trapezoid having a pair of curved arcs, an outer arc 18, and an inner arc 20 as is shown in FIG. 2. The trapezoidal monofilament 10 includes a precursor powder core 12 surrounded by a metal matrix 16, which in some embodiments is silver, a silver alloy, or another noble metal or noble metal alloy. Such a cross-section provides high space filling efficiency in subsequent bundling operations and significantly reduces the incidence of filaments merging together during subsequent size-reducing and deformation texturing operations and the shape of the multifilament assembly nearly approximates that of the shape of the filaments in the processed multifilament composite strand. In addition to drawing, other well known processes may be used to elongate the rod, such as extrusion, strip, bar or Turk's head rolling or swaging.

The prior art teaches that when a multifilamental composite is formed using hexagonal cross-section monofilaments, it is important that the composite be properly consolidated under conditions and in a manner that results in adherent, well-bonded interfaces, without undesirable reaction of the component materials, e.g., formation of intermetallic compounds. Thus, the consolidation is carried out under “warm” deformation using high consolidation pressures. Exemplary conditions include deformation at room temperature (relying on frictional heating as the only heat source) or cold welding under compressive stresses that are at least 1.5 times, and in some embodiments, about 2 times the flow stresses of the sheath ductile foil materials. In contrast, the trapezoidal architecture of the present invention allows for the elimination of a consolidation step, such as HIPing that normally required in the processing of multifilamental superconductor oxide bundles. Thus, although a consolidation step may be utilized, in other embodiments of this process, it may be omitted.

The advantages of the multifilament bundle architecture and process is that the fully metal-covered monofilament may be homogeneously deformed to form a well-shaped trapezoidal cross-section filament free of surface breaks or defects, and each filament is surrounded by a very thin and generally uniformly thick layer of a metal matrix.

A number of similarly deformed rods may be repacked into a metallic tube around a central core and deformed again to obtain a multifilament wire of reduced cross-section. The core of the filamental bundle may be pure silver, a reactive metal silver alloy, a metal-coated insulating ceramic or an additional round cross-section monofilament superconductor oxide rod. Typical diameters of the multifilament wire are in the range of about 0.3 to about 10 mm. Consolidation factors such as those described above are also taken into account.

The multifilament wire may be twisted to a desired twist pitch (ca. 0.2-5 cm) and desirably is further processed into a square or rectangular shape of low aspect ratio. The aspect ratio is selected to aid in subsequent texturing operations and is typically on the order of 2:1 to 5:1.

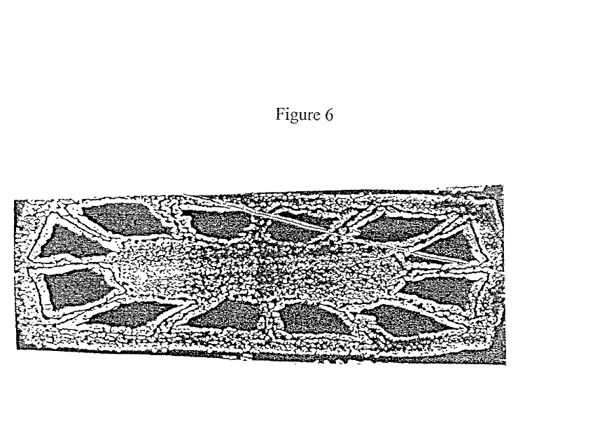

The multifilament wire is then deformation textured. Rolling or pressing may be used to deform the wire and orient the oxide precursor grains. FIG. 6 shows a scanning photomicrograph of a multifilament strand after final processing into a textured oxide superconductor. Alignment of the superconducting oxide grains has been observed in long, thin filaments constrained within a metal matrix. The wire is reduced to final dimension in which at least one dimension of each filament has obtained the desired thickness or width. In one embodiment, the oxide filament is of a dimension on the order of the longest dimension of the oxide superconductor grain. Filaments having thickness on this order, e.g., about 35 microns in some embodiments, about 25 microns in other embodiments, and about 10 microns in other embodiments, and in yet other embodiments, less than about 5 microns, often demonstrate preferential orientation due to constrained growth of the oxide grains. See, International Application No. WO 92/18989, entitled “A Method of Producing Textured Superconducting Oxide Bodies by the Oxidation/Annealing of Thin Metallic Precursors” filed Oct. 29, 1992, the contents of which are incorporated by reference in their entirety.

The wire may be rolled in a single pass or in multiple passes to strains in the range of 30% to 85% cross-sectional area reduction. In the instance where multiple rolling operations are used, typically no intermediate heat treatments are performed. In another embodiment, small diameter rolls are used which minimize the extent of lateral spread of the strand.

In some embodiments, a fully textured precursor oxide phase is obtained using a single high reduction rolling operation, which reduces the composite thickness in the range of 30-85% in a single rolling pass. A high reduction rolling operation has been shown to be highly effective in producing a high density, highly textured oxide phase. The single deformation step introduces a high level of deformation strain, e.g., about 30-85%, and in at least some embodiments, 55-80% strain, by reducing the article thickness in a single step. The high reduction process distributes the deformation energy throughout the article. Thus, the entire filament experiences similar densifying and texturing forces, leading to greater filament uniformity and degree of texture.

Such processing additionally has been found to eliminate undesirable non-uniformities along the length of the oxide filaments, thereby reducing the incidence of filament merger while providing consistently better electrical transport properties in the final article. This is true, regardless of the particular method used to obtain the final oxide superconducting phase. In addition to a single deformation step, more traditional methods of precursor processing which involve multiple annealing and texturing deformation steps may be utilized. Further information on a single step deformation process may be found in PCT International Application No. WO 96/39366, published Dec. 12, 1996, entitled “Simplified Deformation-Sintering Process for Oxide Superconducting Articles,” now U.S. Pat. No. 6,247,224, which is hereby incorporated by reference in its entirety.

BSCCO 2212 may be prepared having either an orthorhombic or tetragonal solid state lattice symmetry. In prior art processes, it is taught to use the tetragonal phase of the BSCCO 2212 oxide superconductor in the formation of the multifilament wire, which then is phase converted in a high temperature process into orthogonal phase BSCCO 2212 prior to texturing. See U.S. Pat. No. 5,942,466, issued Aug. 4, 1999, and entitled “Processing of (Bi,Pb)SCCO Superconductors in Wires and Tapes,” for further details.

It has been found that a multifilament assembly formed of the monofilaments discussed above are able to withstand significant deformation stresses, stresses which might otherwise compromise the integrity of the metallic sheath layer, to thereby increase texture, and thus J_{c}.

The oxidized composite is heat treated to form the oxide superconductor from the oxide precursor powders. In the BSCCO system, this involves the conversion of BSCCO 2212 and secondary phases into the high Tc phase BSCCO 2223. Phase conversion of BSCCO 2212 into BSCCO 2223 may be carried out over a wide processing range. In some embodiments, the processing conditions include heating the article at a temperature of substantially in the range of 815° C. to 860° C. at a P_{O2} substantially in the range of about 0.001 to about 1.0 atm. The exact processing temperature may vary dependant upon the oxygen partial pressure and the total overpressure of the system. In some embodiments, the oxygen partial pressure is in the range of about 0.001-1.0 atm; and is in some embodiments, in the range of about 0.01-0.25 atm. When the multifilamentary superconducting articles are formed into cables, this treatment also sinters (bonds) adjacent strands, as the contacting silver surfaces sinter well under typical oxide superconductor forming conditions (e.g., T>800° C.).

In one embodiment, processing of the BSCCO 2212 (plus secondary phases) precursor into BSCCO 2223 is accomplished under conditions, which partially melt the oxide such that the liquid co-exists with the final oxide superconductor. During the partial melt, non-superconducting material and precursor oxide phases melt and the final oxide superconductor is formed from the melt. The heat treatment thus is conducted in two steps, in which (a) a liquid phase is formed such that the liquid phase co-exists with the final oxide superconductor; and (b) the liquid phase is transformed into the final oxide superconductor.

The above process has been found to advantageously heal any cracks or defects, which may have been introduced into the oxide superconductor filaments, particularly during any deformation operation. The liquid is believed to “wet” the surfaces of cracks located within and at the surfaces of the oxide grains. Once the conditions are adjusted to transform the liquid into the final oxide superconductor, oxide superconductor is formed at the defect site and in effect, “heals” the defect. In an exemplary method, the processing conditions are first adjusted to bring the article under conditions where a liquid phase is formed. It is desired that only a small portion of the oxide composition be transformed into a liquid so that the texturing introduced in previous steps is not lost. In the BSCCO system, in general a temperature in the range of 815-860 C. may be used at a P_{O2} in the range of about 0.001-1.0 atm. In some embodiments, conditions of 820-835 C at 0.075 atm P_{O2} are sufficient. The processing parameters may then be adjusted to bring the article under conditions where the liquid is consumed and the final oxide superconductor is formed from the melt. In general, a temperature in the range of about 780-845 C may be used at a P_{O2} in the range of about 0.01-1.0 atm. In some embodiments, conditions of about 820-790° C. at 0.075 atm P_{O2} is sufficient. See U.S. Pat. No. 5,635,456, issued Jun. 3, 1997 and entitled “Processing for Bi/Sr/Ca/Cu/O-2223 Superconductors,” which is hereby incorporated by reference in its entirety, for further details.

The phase converting heat treatments may be coupled with mechanical or hydrostatic constraint of the article, which mimics the positive effects of rolling without applying mechanical forces that disrupt the oxide layer. The constraining force may be uniaxially applied, i.e., in a single direction, or it may be isostatically applied, i.e., uniform in all directions. In another embodiment, uniaxial pressure, is applied to maintain density and texture in the plane or direction of elongation. In some embodiments, an isostatic pressure is used as the constraining force. When used at elevated temperature conditions, the process is known as hot isostatic pressing (HIP). In some embodiments, pressures may be in the range of about 10-2500 atm (1-250 MPa), and in some embodiments about 25-100 atm (2.5-10 MPa).

Improvements in density and texture retention during phase conversion have been observed for pressures in the range of about 40-85 atm (4-8.5 MPa). Pressure is applied at a temperature and an oxygen partial pressure that facilitates phase conversion of the precursor into the oxide superconductor. Further detail is provided in co-pending application entitled “Simultaneous Constraint And Phase Conversion Processing of Oxide Superconductors,” U.S. patent application Ser. No. 09/655,882, filed Sep. 20, 2000, which is hereby incorporated by reference in its entirety.

Additional processes are contemplated within the scope of the invention, dependent upon the intended use of the superconducting article. For example, in high stress applications it may be desirable to laminate the superconducting article onto a stainless steel strip after the final reaction step. This may be accomplished using an adhesive solder or direct sintering.

The invention is illustrated by the following examples which are presented for the purpose of illustration only and are not intended to be limiting of the invention, the full scope of which is set forth in the claims which follow.

### EXAMPLE 1

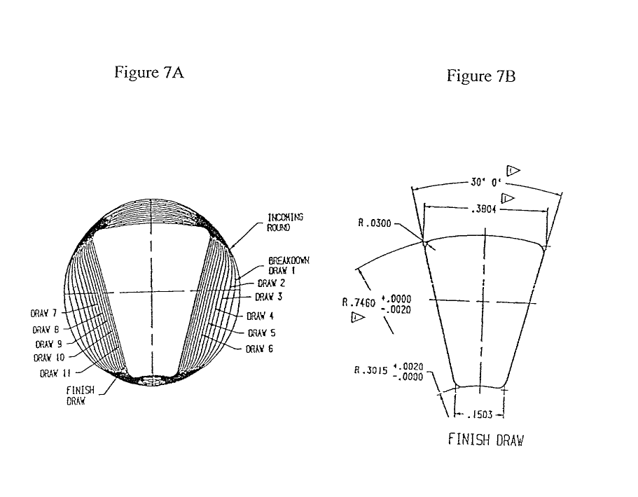

This example describes the preparation and characterization of a multifilament composite strand or tape made from monofilament rods of the disclosed trapezoidal architecture. In a first trial, a standard cylindrical monofilament rod containing precursor powder to the BSCCO 2223 superconductor was deformation processed by drawing according using a standard round wire die sequence (nominally drawn to decrease diameter of rod by about 10% per pass) such that the diameter of the monofilament wire was about 0.55 inches. The round wire was then subjected to dies with work openings manufactured according to the shape sequence illustrated in FIG. 7A. After a series of shapings with the die, the cross-sectional profile of the round cross-section monofilament rod was transformed into a trapezoidal cross-section as shown in FIG. 7B. Twelve truncated pie-shaped filaments and one cylindrical rod for the central core having a diameter of about 0.6 inches were assembled to form a filament bundle.

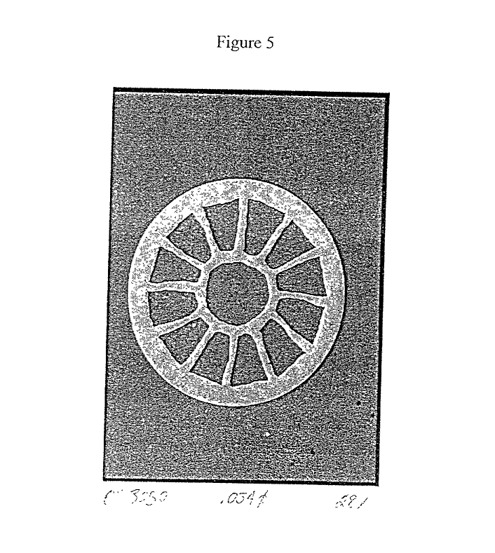

In a second run, another monofilament rod was deformation processed by drawing to a diameter of about 0.597 inches and shaped into a filament having a trapezoidal cross-section. The rod was cleaned and cut to lengths of about 25 inches, and 12 trapezoidal filaments were assembled around a single round cross-section to form a filament bundle. This bundle was then inserted into a 1.505 inch inner diameter (ID)×1.75 inch outer diameter (OD) silver alloy standard multi bundle tube to form a multifilament assembly, followed by the welding of end caps and evacuation with the standard isostatic pressing step omitted. The multifilament assembly, or pie-bundle billet was then drawn down in diameter via consecutive passes through progressively smaller dies according to the standard drawing process. The pie-shape architecture of a superconductor oxide assembly after drawing into its final drawn size is clearly depicted in the low magnification photomicrograph of FIG. 5. After drawing, the wire was rolled and processed into reacted BSCCO 2223 composite tape according to the standard process for OPIT BSCCO 2223.

Short lengths (about 0.5 m and 1 m) of this finished composite strand which were cut from the long-lengths of drawn multifilament assembly were tested for electrical and dimensional properties. The data is summarized in Table 1.

TABLE 1

| Strand Characteristic | | | |
|---|---|---|---|
| Measured | Data | | Comment |
| Cross-section | about 0.38 cm × | | A 13-filament trapezoidal |
| dimension | 0.021 cm | | cross-section tape and a |
| Sample lengths | about 0.5 m to about | | 55-filament hexagonal |
| | 1.0 m (cut from the | | cross-section tape |
| | ends of a 150 m | | were created having |
| | piece) | | these dimensions. |
| Number of samples | 8 | | |
| tested | | | |
| Average Ic of | 130 | A | Measured at the standard |
| trapezoidal tape | | | 1 μV/cm criterion. |
| Average Je of | 16.3 | kA/cm² | Measured as whole wire |
| trapezoidal tape | | | critical current density. |
| | | | Je is calculated by divid- |
| | | | ing the Ic by the cross- |
| | | | sectional area of the tape. |
| Space fill factor of | 41% | | The space fill factor is |
| trapezoidal tape | | | measured by dividing the |
| Space fill factor of | 38% | | total area of the super- |
| prior art hexagonal tape | | | conducting filament by |
| Average Ic of prior art | 120 | A | the total area of the |
| hexagonal tape | | | superconducting filament |
| Average Je of prior art | 15 | kA/cm² | plus silver (matrix sil- |
| hexagonal tape | | | ver and silver tubing). |

The same standard monofilament rods as described above were used to create a prior art 55-filament hexagonal cross-section multifilament assembly and a 13-filament trapezoidal cross-section multifilament assembly of the present invention. After final processing into respective tapes, the electrical properties of these tapes were measured. As shown in Table 1, the measured average Je and Ic levels exceeded the same properties of a standard control tapes made from a 55-filament hexagonal cross-section multifilament assembly, which was processed in parallel at approximately the same timeframe at a Je of about 15 kA/cm². In fact, the fill factor of the trapezoidal cross-section tape evidenced was 8% greater than the fill factor of the prior art hexagonal cross-section tape. The fill factor was increased even though the identical standard cylindrical monofilaments were used as the starting materials for tapes of both architectures. Further, it was observed that manufacturing considerations such as ease of long length processing was not adversely affected when the rods were formed into trapezoidal cross-sections. In fact, drawing response in terms of center voiding (or “center-bursting”) was improved.

What is claimed is:

1. A monofilament rod for use in preparing a multifilament oxide superconducting strand, comprising:
an oxide filament in a ductile metal matrix, said oxide comprising an oxide superconductor or precursor thereto; and
wherein said rod has a cross-sectional geometry of a quadrilateral having two opposing sides of same or unequal length connected by two linear sides of the same or unequal length.

2. The rod of claim 1 wherein the two opposing sides comprise two concentric arcs of unequal length comprising a larger outer arc and a smaller inner arc.

3. The rod of claim 1 wherein the quadrilateral is selected from the group consisting of a trapezoid and a trapezium.

4. The rod of claim 1 wherein the length of the outer arc is greater than the length of the inner arc such that an angle between the two linear sides of the quadrilateral is from about 10 to about 180 degrees.

5. The rod of claim 4 wherein the angle is from about 20 to about 60 degrees.

6. The rod of claim 4 wherein the angle is about 20 to about 45 degrees.

7. The rod of claim 1 wherein the cross-sectional geometry of the rod comprises a trapezoid.

8. The rod of claim 1, wherein the ductile metal matrix comprises silver or a silver alloy.

9. The rod of claim 1 wherein the oxide superconductor comprises a bismuth-strontium-calcium-copper oxide (BSCCO) superconductor.

10. The rod of claim 1 wherein the oxide superconductor comprises a lead-bismuth-strontium-calcium-copper oxide (BSCCO) superconductor.

11. A monofilament rod for use in preparing a multifilament oxide superconducting strand comprising:
an oxide filament in a ductile metal matrix, said oxide comprising an oxide superconductor or precursor thereto,
wherein said rod possesses a space-filling geometry such that, when multiple monofilament rods are assembled into a billet, such assembly is characterized by the absence of sharp angles.

12. The rod of claim 11 wherein the billet comprises a cylindrical tube containing an array of monofilaments having a cross-section geometry of a quadrilateral and said monofilaments are arranged about a central core.

13. The rod of claim 11 wherein the quadrilateral comprises a trapezoid.

14. The rod of claim 11 wherein the oxide superconductor comprises a bismuth-strontium-calcium-copper oxide (BSCCO) superconductor.

15. The rod of claim 11 wherein the oxide superconductor comprises a lead-bismuth-strontium-calcium-copper oxide (BSCCO) superconductor.

16. A multifilamentary assembly for forming a superconducting composite article comprising:
a plurality of oxide superconducting filaments in a conductive, ductile metal matrix arranged about a central core to form a filament bundle,
wherein each filament has a cross-sectional geometry of a quadrilateral having two opposing sides of same or unequal length connected by two linear sides of the same or unequal length.

17. The multifilamentary assembly of claim 16 further comprising:
a metallic sheath having an outer diameter and an inner diameter which substantially surrounds the outermost surface of the multifilamentary assembly.

18. The multifilamentary assembly of claim 16 wherein the two opposing sides comprise two concentric arcs of unequal length comprising a larger outer arc and a smaller inner arc.

19. The multifilamentary assembly of claim 16 wherein the quadrilateral is selected from the group consisting of a trapezoid and a trapezium.

20. The multifilamentary assembly of claim 16 wherein the length of the outer arc is greater than the length of the inner arc such that an angle between the two linear sides of the quadrilateral is from about 10 to about 180 degrees.

21. The multifilamentary assembly of claim 20 wherein the angle is from about 20 to about 60 degrees.

22. The multifilamentary assembly of claim 20 wherein the angle is about 20 to about 45 degrees.

23. The multifilamentary assembly of claim 16 wherein the cross-sectional geometry of the each filament comprises a trapezoid.

24. The multifilamentary assembly of claim 16 wherein the ductile metal matrix comprises silver or a silver alloy.

25. The multifilamentary assembly of claim 16 wherein each filament possesses a space-filling geometry such that, when multiple monofilament rods are assembled into a billet, such assembly is characterized by the absence of sharp angles.

26. The multifilamentary assembly of claim 16 wherein the central core comprises an array of filaments having a cross-section geometry of a quadrilateral and said filaments are arranged about a second central core.

27. The multifilamentary assembly of claim 17 wherein the assembly has a fill factor of superconducting material of greater than about 35%.

28. The multifilamentary assembly of claim 17 wherein the assembly has a fill factor of superconducting material of greater than about 40%.

29. The multifilamentary assembly of claim 16 wherein the filaments are arranged about a central core selected from the group consisting of an electrically resistive core, a conductive core, and an oxide superconductor core.

30. The multifilamentary assembly of claim 16 wherein the filaments are arranged in a single concentric layer about the central core.

31. The multifilamentary assembly of claim 16 wherein the filaments are arranged in multiple concentric layers about the central core.

32. The multifilamentary assembly of claim 31 wherein a first concentric layer is comprised of filaments having arcs of uniform length, and a second concentric layer is comprised of filaments having arcs of uniform length different from that of the first concentric layer.

33. The multifilamentary assembly of claim 32 wherein a first concentric layer is comprised of filaments having arcs of unequal length and linear sides of uniform length arranged about the central core, and a second concentric layer arranged about the first concentric layer, the second concentric layer comprised of filaments having arcs of unequal length and linear sides of uniform length.

34. The multifilamentary assembly of claim 16 wherein the assembly is comprised of from about 3 to about 1000 oxide superconducting filaments.

35. The multifilamentary assembly of claim 16 wherein the assembly is comprised of 6-50 oxide superconducting filaments.

36. The multifilamentary assembly of claim 16 wherein the assembly is comprised of 6-18 oxide superconducting filaments.

37. The multifilamentary assembly of claim 16 wherein the oxide superconductor comprises a bismuth-strontium-calcium-copper oxide (BSCCO) superconductor.

38. The multifilamentary assembly of claim 16 wherein the oxide superconductor comprises a lead-bismuth-strontium-calcium-copper oxide (BSCCO) superconductor.

39. The multifilamentary assembly of claim 17 wherein the filaments are arranged around a core to form a filament bundle and the diameter of the filament bundle is less than the inner diameter of the metallic sheath by less than about 10%.

40. The multifilamentary assembly of claim 17 wherein the filaments are arranged around a core to form a filament bundle and the diameter of the filament bundle is about 2% less than the inner diameter of the metallic sheath.

41. A method of making a multifilamentary superconducting composite article, comprising the steps of:
forming an elongated multifilamentary assembly comprising a plurality of oxide filaments in a ductile metal matrix assembled about a central core to form a filament bundle, wherein each filament has a cross-sectional geometry of a quadrilateral having two opposing sides of same or unequal length connected by two linear sides of the same or unequal length, and said oxide comprises an oxide superconductor or precursor thereto;
processing the assembly to reduce composite cross-sectional area, to adhere assembly elements to one another, and to induce texture in the precursor oxide filaments; and
converting the precursor oxide into an oxide superconductor, whereby a multifilamentary superconducting composite is obtained.

42. The method of claim 41, wherein the step of forming an elongated multifilamentary composite comprises:
introducing a metallic sheath around the filament bundle to produce a filament bundle/sheath composite; and
deforming the composite to reduce the diameter of a cross-section of the composite.

43. The method of claim 41 wherein the two opposing sides comprise two concentric arcs of unequal length comprising a larger outer arc and a smaller inner arc.

44. The method of claim 41 wherein the quadrilateral is selected from the group consisting of a trapezoid and a trapezium.

45. The method of claim 41 wherein the length of the outer arc is greater than the length of the inner arc such that an angle between the two linear sides of the quadrilateral is from about 10 to about 180 degrees.

46. The method of claim 41 wherein the angle is from about 20 to about 60 degrees.

47. The method of claim 41 wherein the angle is about 20 to about 45 degrees.

48. The method of claim 41 wherein the cross-sectional geometry of the each filament comprises a trapezoid.

49. The method of claim 41 wherein the ductile metal matrix comprises silver or a silver alloy.

50. The method of claim 41 wherein each filament possesses a space-filling geometry such that, when multiple monofilament rods are assembled into a filament bundle, such bundle is characterized by the absence of sharp angles.

51. The method of claim 41 wherein the central core comprises an array of filaments having a cross-section geometry of a quadrilateral and said filaments are arranged about a second central core.

52. The method of claim 41 wherein the assembly has a fill factor of superconducting material of greater than about 35%.

53. The method of claim 41 wherein the assembly has a fill factor of superconducting material of greater than about 40%.

54. The method of claim 41 wherein the filaments are arranged about a central core selected from the group consisting of an electrically resistive core, a conductive core, and an oxide superconductor core.

55. The method of claim 41 wherein the filaments are arranged in a single concentric layer about the central core.

56. The method of claim 41 wherein the filaments are arranged in multiple concentric layers about the central core.

57. The method of claim 41 wherein a first concentric layer is comprised of filaments having arcs of uniform length, and a second concentric layer is comprised of filaments having arcs of uniform length different from that of the first concentric layer.

58. The method of claim 41 wherein a first concentric layer is comprised of filaments having arcs of unequal length and linear sides of uniform length arranged about the central core, and a second concentric layer arranged about the first concentric layer, the second concentric layer comprised of filaments having arcs of unequal length and linear sides of uniform length.

59. The method of claim 41 wherein the assembly is comprised of from about 3 to about 1000 oxide superconducting filaments.

60. The method of claim 41 wherein the assembly is comprised of 6-50 oxide superconducting filaments.

61. The method of claim 41 wherein the assembly is comprised of 6-18 oxide superconducting filaments.

62. The method of claim 41 wherein the oxide superconductor comprises a bismuth-strontium-calcium-copper oxide (BSCCO) superconductor.

63. The method of claim 41 wherein the oxide superconductor comprises a lead-bismuth-strontium-calcium-copper oxide (BSCCO) superconductor.

64. The method of claim 41wherein the diameter of the filament bundle is less than the inner diameter of the metallic sheath by less than about 10%.

65. The method of claim 41 wherein the diameter of the filament bundle is less than the inner diameter of the metallic sheath by less than about 2%.

66. The method of claim 41, wherein the core is solid.

67. The method of claim 41, wherein the composite is textured by a large reduction rolling on the order of 40-85% reduction in thickness.

68. The method of claim 67, wherein the composite is textured in a constrained rolling operation.

69. A superconducting composite article comprising a plurality of oxide superconducting filaments in a conductive ductile metal matrix, produced according to the method of claim 41, wherein the article has a cross-sectional width in the range of 100-8000 μm and a cross-sectional thickness in the range of 25-500 μm.

70. The composite article of claim 69, wherein the article has a cross-sectional width less than 300 μm and a cross-sectional thickness less than 100 μm.

71. The composite article of claim 69, wherein the conductive matrix metal comprises silver or a silver alloy.

72. The composite article of claim 69, wherein the article is comprised of from about 3 to about 1000 oxide superconducting filaments.

73. The composite article of claim 69, wherein the article is comprised of about 6 to about 50 oxide superconducting filaments.

74. The composite article of claim 69, wherein the article is comprised of from about 6 to about 18 oxide superconducting filaments.

75. The composite article of claim 69, wherein the article has a cross-sectional aspect ratio of less than 20:1.

76. The composite article of claim 69, wherein the article has a cross-sectional aspect ratio of about 2:1 to about 5:1.

77. The composite article of claim 69, wherein the oxide superconductor comprises a bismuth-strontium-calcium-copper oxide (BSCCO) superconductor.

78. The composite article of claim 69, wherein the oxide superconductor comprises a lead-bismuth-strontium-calcium-copper oxide (BSCCO) superconductor.
